(19) United States
(12) Patent Application Publication
(10) Pub. No.: US 2026/0038295 A1
(43) Pub. Date: Feb. 5, 2026

(54) DRESS CODE DISCRIMINATION METHOD, PERSON IDENTIFICATION MODEL TRAINING METHOD AND DEVICE

(71) Applicant: BOE TECHNOLOGY GROUP CO., LTD., Beijing (CN)

(72) Inventors: Jingru WANG, Beijing (CN); Fanhao KONG, Beijing (CN)

(73) Assignee: BOE TECHNOLOGY GROUP CO., LTD., Beijing (CN)

(21) Appl. No.: 18/996,084

(22) PCT Filed: Nov. 30, 2022
(86) PCT No.: PCT/CN2022/135526

§ 371 Date: Jan. 17, 2025

(51) Int. Cl. G06V 40/10; G06V 10/26; G06V 10/75; G06V 10/77

(52) U.S. Cl. CPC G06V 40/103; G06V 10/26; G06V 10/751; G06V 10/7715

(57) ABSTRACT

A dress code discrimination method, a person re-identification model training method, and device. The dress code discrimination method includes: performing human body detection on a to-be-identified image to obtain a first human body detection image of a target person in the to-be-identified image; performing human body region division on the first human body detection image to obtain a target human body region image of the target person; using a person identification model to extract features from the target human body region image of the target person to obtain a first feature vector; comparing the first feature vector with a second feature vector of a target human body region in a dress code sample image to obtain a comparison result; determining whether the dress of the target human body region of the target person complies with the dress code according to the comparison result.

### TECHNICAL FIELD

Embodiments of the present application relate to the field of image processing technologies, and in particular to a dress code discrimination method, a person identification model training method and device.

### BACKGROUND

With development of science and technology, computer vision technology has been more and more widely used in life and production. In factories, bank lobbies and other places, it is necessary to restrict the dress code of employees. The pedestrian re-identification technology in the computer vision technology can compare similarity between a real human image and a given dress code sample image, thereby helping to determine whether the employees' dress meets requirements.

However, the current pedestrian re-identification technology cannot accurately identify the dress code of each part of the human body.

### SUMMARY

Embodiments of the present application provides a dress code discrimination method, a person identification model training method and device, which can solve the problem that the pedestrian re-identification technology in the related art cannot accurately identify the dress code of each part of the human body.

In order to solve the above technical problems, the present application is implemented as follows.

According to a first aspect, one embodiment of present application provides a dress code discrimination method, including:
performing human body detection on a to-be-identified image to obtain a first human body detection image of a target person in the to-be-identified image;
performing human body region division on the first human body detection image to obtain a target human body region image of the target person;
using a person identification model to extract features from the target human body region image of the target person to obtain a first feature vector;
comparing the first feature vector with a second feature vector of a target human body region in a dress code sample image to obtain a comparison result;
determining whether dress of the target human body region of the target person complies with a dress code according to the comparison result.

Optionally, the performing human body region division on the first human body detection image, includes:
using a preprocessing model to perform human body key point extraction on the first human body detection image to obtain a first human body key point;
dividing the first human body detection image into human body regions according to the first human body key point.

Optionally, before comparing the first feature vector with the second feature vector of the target human body region in the dress code sample image, the method further includes:
performing human body detection on the dress code sample image to obtain a second human body detection image;
performing human body region division on the second human body detection image to obtain a target human body region image of the dress code sample image;
using the person identification model to extract features from the target human body region image of the dress code sample image to obtain a second feature vector.

Optionally, the comparing the first feature vector with a second feature vector of a target human body region in a dress code sample image to obtain a comparison result, includes:
calculating cosine similarity of the first feature vector and the second feature vector of the target human body region in the dress code sample image to obtain similarity information as the comparison result.

Optionally, the determining whether a dress of the target human body region of the target person complies with a dress code according to the comparison result, includes:
for one target human body region of the target person, if a comparison result of N frames of the to-be-identified image including the target person indicates that similarity information between the first feature vector of the target human body region in at least M frames of the to-be-identified image and the second feature vector of the target human body region in the dress code sample image does not reach a preset threshold, determining that the dress of the target human body region does not comply with the dress code; wherein N is a positive integer greater than or equal to 1, and M is a positive integer greater than or equal to 1 and less than N.

According to a second aspect, one embodiment of present application provides a person identification model training method, including:
determining multiple training image pairs, wherein each of the training image pairs includes at least two training images;
performing human body detection on the training image in the training image pair to obtain a third human body detection image of the training image;
performing human body region division on the third human body detection image to obtain a target human body region image;
using a to-be-trained person identification model to perform feature extraction on the target human body region image to obtain a third feature vector;
comparing the third feature vectors of target human body regions of various training images in the training image pair to obtain a comparison result;
optimizing the to-be-trained person identification model according to the comparison result, to obtain a trained person identification model.

Optionally, the performing human body region division on the third human body detection image, includes:
using a preprocessing model to perform human body key point extraction on the third human body detection image to obtain a third human body key point;
dividing the third human body detection image into human body regions according to the third human body key point.

Optionally, the determining multiple training image pairs, includes:
using the preprocessing model to extract human body attribute information from candidate images to obtain human body attribute information of the candidate images;
selecting training images from the candidate images to form the training image pairs according to the human body attribute information.

Optionally, the human body attribute information includes human body orientation, and the selecting training images from the candidate images to form the training image pairs according to the human body attribute information, includes: selecting training images of a same person with same and/or different orientations from the candidate images as training images in the training image pair;
and/or,
the human body attribute information includes human body orientation and clothing color, and the selecting training images from the candidate images to form the training image pairs according to the human body attribute information, includes: selecting training images of different persons wearing a same color clothing and facing same orientation from the candidate images as the training images in the training image pair.

Optionally, the selecting training images of a same person with same and/or different orientations from the candidate images as training images in the training image pair, includes:
for one training image, from multiple candidate images including the same person, selecting a first image of a first difficulty with a first probability, selecting a second image of a second difficulty with a second probability, and selecting a third image of a third difficulty with a third probability, as the training images in the training image pair;
wherein the first difficulty means that: the person in one of the training image and the first image is facing forward, and the person in the other one of the training image and the first image is facing backward; or, the person in one of the training image and the first image is facing left, and the person in the other one of the training image and the first image is facing right;
the second difficulty means that: the person in one of the training image and the second image is facing forward, and the person in the other one of the training image and the second image is facing left or right; or, the person in one of the training image and the first image is facing backward, and the person in the other one of the training image and the second image is facing left or right;
the third difficulty means that the person in the training image and the third image is facing the same direction.

Optionally, the selecting training images of different persons wearing the same color clothing and facing same orientation from the candidate images as the training images in the training image pair, includes:
for one training image, selecting candidate images including a different person from the training image;
calculating similarity information between the training image and the candidate images, where the similarity information is determined by at least one of the following: clothing color, hat wearing, and person orientation in the training image and the candidate images;
dividing the candidate images into multiple sets according to the similarity information of the candidate images;
selecting candidate images from different sets as training images in the training image pair.

Optionally, the determining multiple training image pairs, includes:
for one training image, selecting a candidate image including a different person from the training image;
performing human body detection on the candidate image to obtain a fourth human body detection image of the candidate image;
using a preprocessing model to perform human key point extraction from the fourth human body detection image to obtain second human key points;
according to the second human body key points, performing human body region division on the fourth human body detection image to obtain a target human body region image of the fourth human body detection image;
determining mean and variance of the target human body region image of the fourth human body detection image on RGB three channels;
converting the target human body region image of the fourth human body detection image into HSV space, and calculating mean and variance on three HSV channels after conversion into the HSV space;
according to the mean and variance on the three RGB channels and the mean and variance on the three HSV channels, obtaining image features after dimensionality reduction;
clustering image features after dimensionality reduction of the multiple candidate images, and dividing the multiple candidate images into different clusters;
selecting candidate images from different clusters as training images in the training image pair.

According to a third aspect, one embodiment of present application provides a dress code discrimination device, including:
a first human body detection module used to perform human body detection on a to-be-identified image to obtain a first human body detection image of a target person in the to-be-identified image;
a first human body region division module used to perform human body region division on the first human body detection image to obtain a target human body region image of the target person;
a first feature extraction module used to use a person identification model to extract features from the target human body region image of the target person to obtain a first feature vector;
a first comparison module used to compare the first feature vector with a second feature vector of a target human body region in a dress code sample image to obtain a comparison result;
a determination module used to determine whether dress of the target human body region of the target person complies with a dress code according to the comparison result.

According to a fourth aspect, one embodiment of present application provides a person identification model training device, including:
a determination module used to determine multiple training image pairs, wherein each of the training image pairs includes at least two training images;
a third human body detection module used to perform human body detection on the training image in the training image pair to obtain a third human body detection image in the training image;
a third human body region division module used to perform human body region division on the third human body detection image to obtain a target human body region image;
a third feature extraction module used to use a to-be-trained person identification model to perform feature extraction on the target human body region image to obtain a third feature vector;
a second comparison module used to compare the third feature vectors of target human body regions of various training images in the training image pair to obtain a comparison result;
an optimization module used to optimize the to-be-trained person identification model according to the comparison result, to obtain a trained person identification model.

According to a fifth aspect, one embodiment of present application provides an electronic device, including: a processor, a memory, and a program stored in the memory and executable on the processor; wherein when the program is executed by the processor, the steps of the dress code discrimination method according to the first aspect or the second aspect are implemented.

According to a sixth aspect, one embodiment of present application provides a non-volatile computer-readable storage medium, including: a computer program stored thereon; wherein when the program is executed by the processor, the steps of the dress code discrimination method according to the first aspect or the second aspect are implemented.

In the embodiment of the present application, before using the pedestrian re-identification module to identify the dress of the target person in the to-be-identified image, the human body detection image detected in the to-be-identified image is divided into human body regions to obtain human body region images of the target person, and the pedestrian re-identification module is used to identify each human body region image separately, thereby accurately identifying the dress code of each part of the human body and improving recognition accuracy.

### BRIEF DESCRIPTION OF THE DRAWINGS

Various other advantages and benefits will become apparent to those of ordinary skill in the art by reading the detailed description of the following preferred embodiments. The accompanying drawings are only for the purpose of illustrating the preferred embodiments and are not to be considered as limiting the present application. Further, the same reference symbols are used throughout the accompanying drawings to represent the same components. In the accompanying drawings:

FIG. 1 is a schematic flow chart of a dress code discrimination method according to an embodiment of the present application;

FIG. 2 is a schematic flow chart of a person identification model training method according to an embodiment of the present application;

FIG. 3 is a schematic diagram of a person identification model training method according to an embodiment of the present application;

FIG. 4 is a schematic diagram of a preprocessing model according to an embodiment of the present application;

FIG. 5 is a schematic diagram of a dress code discrimination device according to an embodiment of the present application;

FIG. 6 is a schematic diagram of a person identification model training device according to an embodiment of the present application; and

FIG. 7 is a schematic diagram of an electronic device according to an embodiment of the present application.

### DETAILED DESCRIPTION

The technical solutions in the embodiments of the present application will be clearly and completely described hereinafter with reference to the accompanying drawings in the embodiments of the present application. Obviously, the described embodiments are part of the embodiments of the present application, rather than all embodiments. Based on the embodiments of the present application, all other embodiments obtained by those of ordinary skill in the art without creative work are within the protection scope of the present application.

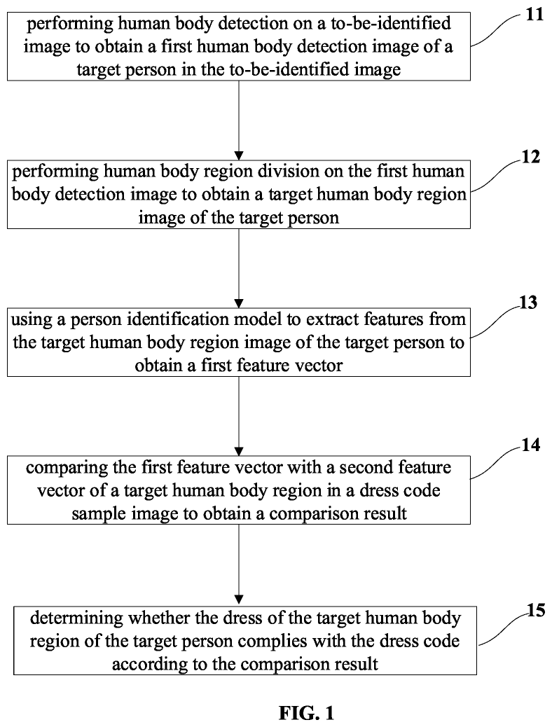

Referring to FIG. 1, one embodiment of the present application provides a dress code discrimination method, including:

Step 11: performing human body detection on a to-be-identified image to obtain a first human body detection image of a target person in the to-be-identified image.

In this embodiment of the present application, a variety of algorithms can be used to perform human body detection on the to-be-identified image. For example, a target detection algorithm such as the yolo-v5 algorithm is used to detect the target person, and a target tracking algorithm such as the sort algorithm is used to track the target.

In the embodiment of the present application, the to-be-identified image may be an image in a surveillance video stream captured by a camera device in a preset place (such as a factory, a bank lobby, etc.).

In the embodiment of the present application, the number of target persons in the to-be-identified image may be one or more. Each target person may be assigned a unique tracking ID.

In the embodiment of the present application, optionally, a designated pedestrian in the to-be-identified image may be detected. For example, for an image in a surveillance video stream of a bank lobby, only bank staff members appearing in the image can be detected. In this case, a target person database needs to be established in advance. The target person database stores facial images of one or more target persons. When performing human body detection on the to-be-identified image, facial recognition is first performed on the detected pedestrian according to the target person database. If the pedestrian in the to-be-identified image is identified as a pedestrian in the target person database, the subsequent steps are executed. If the pedestrian in the to-be-identified image is identified as not a pedestrian in the target person database, the process ends.

In the embodiment of the present application, optionally, all pedestrians in the to-be-identified image may be taken as target persons to perform subsequent dress code identification, for example, in a factory or other place where outsiders are generally not allowed to enter.

Step 12: performing human body region division on the first human body detection image to obtain a target human body region image of the target person.

In the embodiment of the present application, the target human region may be one or more, for example, including a head region, an upper body region and a lower body region. That is, the first human body detection image may be divided into one or more target human region images.

Step 13: using a person identification model to extract features from the target human body region image of the target person to obtain a first feature vector.

In the embodiment of the present application, optionally, when the first human body detection image corresponds to multiple target human body region images, the multiple target human body region images may be spliced first to obtain a spliced image and input it into the person identification model. Of course, instead of splicing, multiple target human body region images can be input into the person identification model separately.

Step 14: comparing the first feature vector with a second feature vector of a target human body region in a dress code sample image to obtain a comparison result.

In the embodiment of the present application, if the first human body detection image corresponds to multiple target human body region images, each target human body region image of the first human body detection image may be compared with the corresponding target human body region image in the dress code sample image.

For example, it is assumed that the target human body region image includes: a head region image, an upper body region image and a lower body region image, at this point, a first feature vector of the head region image in the first human body detection image can be compared with a second feature vector of a head region in the dress code sample image; a first feature vector of the upper body region image in the first human body detection image can be compared with a second feature vector of an upper body region in the dress code sample image; and a first feature vector of the lower body region image in the first human body detection image can be compared with a second feature vector of a lower body region in the dress code sample image, to obtain three comparison results.

Step 15: determining whether the dress of the target human body region of the target person complies with the dress code according to the comparison result.

In the embodiment of the present application, before using the pedestrian re-identification module to identify the dress of the target person in the to-be-identified image, the human body detection image detected in the to-be-identified image is divided into human body regions to obtain human body region images of the target person, and the pedestrian re-identification module is used to identify each human body region image separately, thereby accurately identifying the dress code of each part of the human body and improving recognition accuracy.

In the embodiment of the present application, optionally, performing human body region division on the first human body detection image, includes:

Step 121: using a preprocessing model to perform human body key point extraction on the first human body detection image to obtain a first human body key point.

In the embodiment of the present application, human body key points may include, for example, top of the head, the neck, the limbs and other key points of the human body.

Step 122: dividing the first human body detection image into human body regions according to the first human body key point.

In the embodiment of the present application, optionally, before comparing the first feature vector with the second feature vector of the target human body region in the dress code sample image, the method further includes:
Step 01: performing human body detection on the dress code sample image to obtain a second human body detection image;
Step 02: performing human body region division on the second human body detection image to obtain a target human body region image in the dress code sample image;
Step 03: using the person identification model to extract features from the target human body region image of the dress code sample image to obtain a second feature vector.

In the embodiment of the present application, before using the person identification model to perform dress code identification on the target person in the to-be-identified image, the dress code sample image is identified, and different dress code sample images are identified in advance for different places. When application placed change, there is no need to re-collect training images to train the person identification model, and only the dress code sample image needs to be replaced.

In the embodiment of the present application, optionally, comparing the first feature vector with the second feature vector of the target human body region in the dress code sample image to obtain a comparison result, includes: calculating cosine similarity of the first feature vector and the second feature vector of the target human body region in the dress code sample image to obtain similarity information as the comparison result.

Of course, in some other embodiments of the present application, the similarity calculation is not limited to using cosine similarity, and other methods can also be used to calculate the similarity.

In the embodiment of the present application, optionally, determining whether the dress of the target human body region of the target person complies with the dress code according to the comparison result, includes: for one target human body region of the target person, if the comparison result of N frames of the to-be-identified image including the target person indicates that similarity information between the first feature vector of the target human body region in at least M frames of the to-be-identified image and the second feature vector of the target human body region in the dress code sample image does not reach a preset threshold, determining that the dress of the target human body region does not comply with the dress code; where N is a positive integer greater than or equal to 1, and M is a positive integer greater than or equal to 1 and less than N.

For example, 5 (i.e., N) frames of the to-be-identified image including the target person can be identified, and each target human body region (such as the head region, upper body region, and lower body region) in each frame of the to-be-identified image is compared with the corresponding target human body region in the dress code sample image. It is assumed that the similarity information of 3 (i.e., M) frames of the head region image does not reach a preset threshold (such as 0.45), it is determined that the dress of the head region of the target person does not comply with the dress code.

In the embodiment of the present application, optionally, after determining whether the dress of the target human body region of the target person complies with the dress code according to the comparison result, the method further includes: outputting a warning message when the comparison result indicates that the dress of the target human body region does not comply with the dress code. For example, the output warning message may be: Zhang San's hat is not worn in accordance with the dress code.

The following describes a training method of the person identification model in the above embodiment.

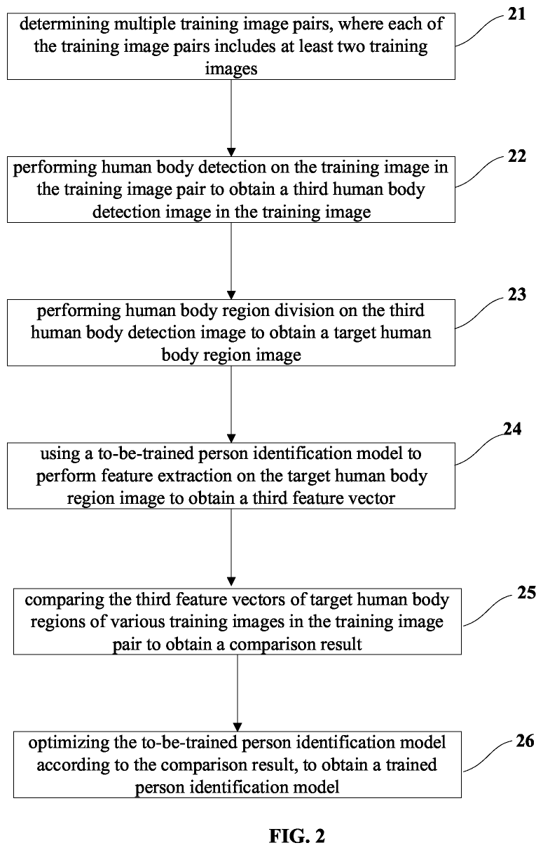

Referring to FIG. 2, one embodiment of the present application further provides a person identification model training method, including:
Step 21: determining multiple training image pairs, where each of the training image pairs includes at least two training images;
Step 22: performing human body detection on the training image in the training image pair to obtain a third human body detection image in the training image;
Step 23: performing human body region division on the third human body detection image to obtain a target human body region image;
Step 24: using a to-be-trained person identification model to perform feature extraction on the target human body region image to obtain a third feature vector;
Step 25: comparing the third feature vectors of target human body regions of various training images in the training image pair to obtain a comparison result;
Step 26: optimizing the to-be-trained person identification model according to the comparison result, to obtain a trained person identification model.

Referring to FIG. 3, FIG. 3 is a schematic diagram of a person identification model training method according to an embodiment of the present application. The input of the person re-identification model is a spliced image (i.e., a full-body image) of various target human body region images corresponding to the training image (i.e., a full-body image). In the embodiment of the present application, there are three target human body region images including: a head region image, an upper body region image, and a lower body region image, where feature1, feature2, and feature3 are feature vectors extracted from the head region image, the upper body region image, and the lower body region image, respectively, i.e., head feature vector, upper body feature vector, and lower body feature vector. FC_Total refers to a fully connected network layer, which outputs a full-body feature vector extracted from the full-body image.

In the embodiment of the present application, optionally, when training the person re-identification model, triplet loss and softmax loss may be used for joint training. The joint training means: calculating a weighted average of multiple losses, calculating a derivative of the weighted average with respect to the input, and using the gradient descent method to update network parameters for training.

In the embodiment of the present application, optionally, the performing human body region division on the third human body detection image to obtain a target human body region image, includes:
Step 231: using a preprocessing model to perform human body key point extraction on the third human body detection image to obtain a third human body key point.

In the embodiment of the present application, human body key points may include, for example, top of the head, the neck, the limbs and other key points of the human body. The number of the human body key points may be set as required, for example, 21 human body key points.
Step 232: dividing the third human body detection image into human body regions according to the third human body key point.

For example, the human body detection image can be divided into three regions: head, upper body, and lower body, according to the human body key points.

Taking the head as an example, left and right ear key points are selected as reference to cut out a region [center_x−d, center_x+d, center_y−d, center_y+d] from the entire image. Center_x and center_y are horizontal and vertical coordinates of a midpoint of a line connecting the two key points; and d is a distance between the two key points. The cut image is rotated so that the line connecting the left and right ear key points is horizontal, and the rotated image is modified (resize) to a predetermined size (such as 128*128) as the head region image.

The same method can be used to process the upper body and lower body regions to obtain three images of predetermined sizes. The three images of predetermined sizes are spliced to obtain a full-body image (such as a size of 384*128) as the input of the person identification model.

In the embodiment of the present application, before training the person identification model, human body key points are extracted through the preprocessing model; the human body detection image is divided into regions according to the human body key points, and the divided human body region images are used to train the person identification model, thereby obtaining a person identification model for each human body region, and improving accuracy of the person identification model. Meanwhile, dress information of different parts of the human body is obtained, which enhances the person identification model's ability to recognize detailed information.

In the embodiment of the present application, optionally, the determining multiple training image pairs, includes:
Step 211: using the preprocessing model to extract human body attribute information from candidate images to obtain human body attribute information of the candidate images.

In the embodiment of the present application, optionally, the human body attribute information may include, for example, at least one of the following: upper body clothing color, lower body clothing color, human orientation, whether wearing a hat, whether being blocked, etc.
Step 212: selecting training images from the candidate images to form the training image pairs according to the human body attribute information.

In the embodiment of the present application, before training the person identification model, human body attribute information of the candidate images is extracted through the preprocessing model, and a training image is selected based on the human body attribute information of the candidate images, so that the required training images can be obtained according to different needs, such as performing difficult sample discovery to improve the accuracy of the person identification model.

It is to be noted that the preprocessing model for extracting the human body key points and the preprocessing model for extracting human body attribute information in the embodiment of the present application may be different models or may be integrated into the same model.

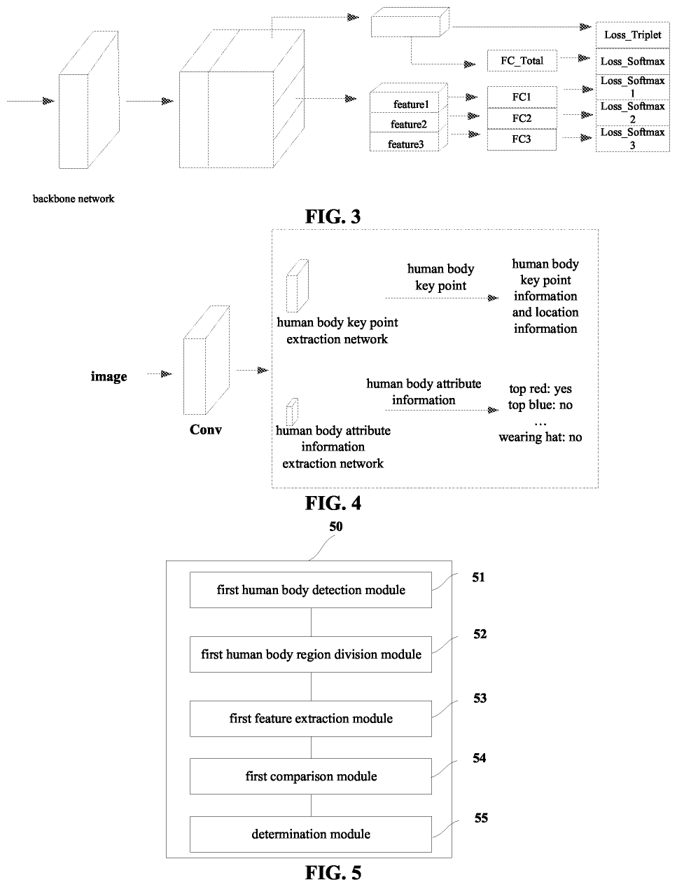

Referring to FIG. 4, FIG. 4 is a schematic diagram of a preprocessing model according to an embodiment of the present application. The preprocessing model includes convolutional neural network (conv). The conv is backbone of the preprocessing model and is used to extract feature vectors from an input image. The conv can select structures such as resnet50 or mobilenetv2. Two network branches in the dotted box are respectively a human body key point extraction network and a human body attribute information extraction network. The human body key point extraction network extracts human body key points from the feature vectors extracted by the conv. Optionally, the last layer of the human body key point extraction network can be a fully connected layer with N1 (for example, 42) dimensions, which outputs horizontal and vertical coordinates of N1/2 (for example, 21) human body key points. The human body attribute information extraction network extracts the human body attribute information from the feature vectors extracted by the conv. Optionally, the last layer of the human body attribute information extraction network can be a fully connected layer with N2 dimensions, and each dimension is a binary classification result of a certain human body attribute, such as whether the top is red, whether the top is green, whether the human body is facing forward, whether the human body is facing backward, etc. N2 is 24 for example. The binary classification result may include: 8 colors for tops, 8 colors for bottoms, 4 human body orientations, whether wearing a hat, whether the head is blocked, whether the upper body is blocked, and whether the lower body is blocked.

The advantage of integrating the human body key point extraction network and the human body attribute information extraction network into one model is that the human body key point extraction network and the human body attribute information extraction network can share the same conv.

A method of selecting training images based on human body attribute information of candidate images is explained in detail hereinafter.

In the embodiment of the present application, optionally, the training image pair can be a triple, for example, [img, img+, img−], where img+ is a different image including the same person as img, and img− is a different image including a different person than img. Of course, in some other embodiments of the present application, the training image pair is not limited to a triple.

In the embodiment of the present application, optionally, the human body attribute information includes human body orientation, and the selecting training images from the candidate images to form the training image pairs according to the human body attribute information, includes: selecting training images of the same person with the same and/or different orientations from the candidate images as training images in the training image pair.

Generally, image pairs of the same person with different body orientations can be used as difficult samples. In the embodiment of the present application, the two most difficult directions are front and back, and left and right; the four second most difficult directions are front and left, front and right, back and left, and back and right; and the image pairs of the same direction have the lowest difficulty. For a given training image img, images are extracted from the most difficult, second most difficult, and least difficult directions to form positive image pairs with img for training.

That is, the selecting training images of the same person with the same and/or different orientations from the candidate images as training images in the training image pair, includes:
for a training image, from multiple candidate images including the same person, selecting a first image of a first difficulty with a first probability, selecting a second image of a second difficulty with a second probability, and selecting a third image of a third difficulty with a third probability, as the training images in the training image pair.

Optionally, the first probability>the second probability>the third probability. For example, the first probability is 50%, the second probability is 30%, and the third probability is 20%.

The first difficulty means that: the person in one of the training image and the first image is facing forward, and the person in the other one of the training image and the first image is facing backward; or, the person in one of the training image and the first image is facing left, and the person in the other one of the training image and the first image is facing right.

The second difficulty means that: the person in one of the training image and the second image is facing forward, and the person in the other one of the training image and the second image is facing left or right; or, the person in one of the training image and the first image is facing backward, and the person in the other one of the training image and the second image is facing left or right.

The third difficulty means that the person in the training image and the third image is facing the same direction.

In some other embodiments of the present application, the first probability, the second probability and the third probability may be the same, or partially the same.

Generally, a pair of pedestrian images of different persons wearing the same color clothing and facing the same orientation can be used as difficult samples, and color has a greater impact on identification difficulty than orientation. In the embodiment of the present application, optionally, the human body attribute information includes human body orientation and clothing color, and the selecting training images from the candidate images to form the training image pairs according to the human body attribute information, includes: selecting training images of different persons wearing the same color clothing and facing same orientation from the candidate images as the training images in the training image pair.

In the embodiment of the present application, optionally, the selecting training images of different persons wearing the same color clothing and facing same orientation from the candidate images as the training images in the training image pair, includes:
for a training image, selecting candidate images including a different person from the training image;
calculating similarity information between the training image and the candidate images, where the similarity information is determined by at least one of the following: clothing color, hat wearing, and person orientation in the training image and the candidate images;
dividing the candidate images into multiple sets according to the similarity information of the candidate images;
selecting candidate images from different sets as training images in the training image pair.

Optionally, candidate images are selected from different sets with different probabilities as training images in the training image pair.

Optionally, the similarity information between the training image img and the candidate images including different persons can be calculated with the following formula:

score=3.5*sameᵤₚₚₑᵣ+3.5*same_{down}+2*sameₕₐₜ+same_{direction}

Where sameᵤₚₚₑᵣ indicates whether the color of the top is the same (0 means different, 1 means the same); same_{down} indicates whether the color of the bottom is the same (0 means different, 1 means the same); sameₕₐₜ indicates whether wearing of a hat is the same (0 means different, 1 means the same), and same_{direction} indicates whether pedestrians are facing the same direction (0 means different, 1 means the same).

The candidate images including different persons can be divided into several sets according to the similarity information, and candidate images are extracted from different sets with a probability of score/10 to form negative image pairs with img for training.

In the embodiment of the present application, the preprocessing model may not be used to mine difficult samples. As an alternative to the method of mining difficult samples including different persons, since clothing color has the most important impact on sample difficulty, in this embodiment, in order to improve the training speed, only color information is considered to mine difficult samples including different persons.

That is, optionally, the determining multiple training image pairs, includes:
for a training image, selecting a candidate image including a different person from the training image;
performing human body detection on the candidate image to obtain a fourth human body detection image of the candidate image;
using a preprocessing model to perform human key point extraction from the fourth human body detection image to obtain second human key points;
according to the second human body key points, performing human body region division on the fourth human body detection image to obtain a target human body region image of the fourth human body detection image;
determining mean and variance of the target human body region image of the fourth human body detection image on RGB three channels;
converting the target human body region image of the fourth human body detection image into the HSV space, and calculating mean and variance on the three HSV channels after conversion into the HSV space; that is, a total of 12-dimensional features are obtained;
according to the mean and variance on the three RGB channels and the mean and variance on the three HSV channels, obtaining image features after dimensionality reduction; optionally, the t-SNE method can be used to reduce the 12-dimensional features to 2 dimensions;
clustering image features after dimensionality reduction of the multiple candidate images, and dividing the multiple candidate images into different clusters; optionally, the DBSCAN method may be used to cluster the image features after dimensionality reduction;
selecting candidate images from different clusters as training images in the training image pair.

Optionally, candidate images are selected from different clusters with different probabilities as training images in the training image pair. For example, images belonging to different clusters and the same cluster as the training image are selected with probabilities of 80% and 20% to form negative sample pairs for training.

In the embodiment of the present application, optionally, the method may further include: training the preprocessing model.

In the embodiment of the present application, when the human body key point extraction network and the human body attribute information extraction network are different preprocessing models, the two preprocessing models are trained separately. When the human body key point extraction network and the human body attribute information extraction network are integrated in one preprocessing model, the human body key point extraction network and the human body attribute information extraction network are trained separately to obtain losses of the two, and the losses of the two are combined (added or weighted addition, etc.) an then calculate the gradient and update the parameters of conv.

In the embodiment of the present application, optionally, wing loss is used to train the human body key point extraction network in the preprocessing model.

In the embodiment of the present application, optionally, BCE Loss is used to train the human body attribute information extraction network in the preprocessing model.

In the above embodiments of the present application, in addition to using human body key points to divide the human body image into regions, a segmentation model can also be used to divide the human body image into regions.

Referring to FIG. 5, one embodiment of the present application further provides a dress code discrimination device 50, including:
a first human body detection module 51 used to perform human body detection on a to-be-identified image to obtain a first human body detection image of a target person in the to-be-identified image;
a first human body region division module 52 used to perform human body region division on the first human body detection image to obtain a target human body region image of the target person;
a first feature extraction module 53 used to use a person identification model to extract features from the target human body region image of the target person to obtain a first feature vector;
a first comparison module 54 used to compare the first feature vector with a second feature vector of a target human body region in a dress code sample image to obtain a comparison result;
a determination module 55 used to determine whether the dress of the target human body region of the target person complies with the dress code according to the comparison result.

Optionally, the first human body region division module 52 is used to use a preprocessing model to perform human body key point extraction on the first human body detection image to obtain a first human body key point; and divide the first human body detection image into human body regions according to the first human body key point.

Optionally, the dress code discrimination device 50 further includes:
a second human body detection module used to perform human body detection on the dress code sample image to obtain a second human body detection image;
a second human body region division module used to perform human body region division on the second human body detection image to obtain a target human body region image in the dress code sample image;
a second feature extraction module used to use the person identification model to extract features from the target human body region image of the dress code sample image to obtain a second feature vector.

Optionally, the first comparison module 54 is used to calculate cosine similarity of the first feature vector and the second feature vector of the target human body region in the dress code sample image to obtain similarity information as the comparison result.

Optionally, the determination module 55 is used to, for one target human body region of the target person, if the comparison result of N frames of the to-be-identified image including the target person indicates that similarity information between the first feature vector of the target human body region in at least M frames of the to-be-identified image and the second feature vector of the target human body region in the dress code sample image does not reach a preset threshold, determine that the dress of the target human body region does not comply with the dress code; where N is a positive integer greater than or equal to 1, and M is a positive integer greater than or equal to 1 and less than N.

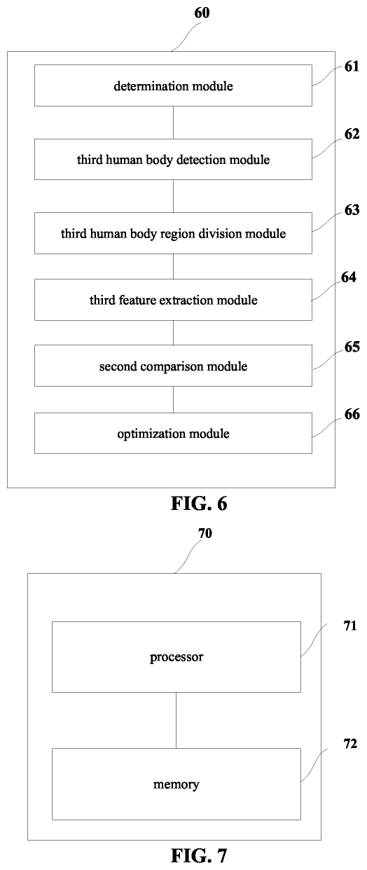

Referring to FIG. 6, one embodiment of the present application further provides a person identification model training device 60, including:
a determination module 61 used to determine multiple training image pairs, where each of the training image pairs includes at least two training images;
a third human body detection module 62 used to perform human body detection on the training image in the training image pair to obtain a third human body detection image in the training image;
a third human body region division module 63 used to perform human body region division on the third human body detection image to obtain a target human body region image;
a third feature extraction module 64 used to use a to-be-trained person identification model to perform feature extraction on the target human body region image to obtain a third feature vector;
a second comparison module 65 used to compare the third feature vectors of target human body regions of various training images in the training image pair to obtain a comparison result;
an optimization module 66 used to optimize the to-be-trained person identification model according to the comparison result, to obtain a trained person identification model.

Optionally, the third human body region division module 63 is used to use a preprocessing model to perform human body key point extraction on the third human body detection image to obtain a third human body key point; dividing the third human body detection image into human body regions according to the third human body key point.

Optionally, the determination module 61 is used to use the preprocessing model to extract human body attribute information from candidate images to obtain human body attribute information of the candidate images; and selecting training images from the candidate images to form the training image pairs according to the human body attribute information.

Optionally, the human body attribute information includes human body orientation, and the determination module 61 is used to select training images of the same person with the same and/or different orientations from the candidate images as training images in the training image pair.

Optionally, the human body attribute information includes human body orientation and clothing color, and the determination module 61 is used to select training images of different persons wearing the same color clothing and facing same orientation from the candidate images as the training images in the training image pair.

Optionally, the determination module 61 is used to, for a training image, from multiple candidate images including the same person, select a first image of a first difficulty with a first probability, select a second image of a second difficulty with a second probability, and select a third image of a third difficulty with a third probability, as the training images in the training image pair; where the first difficulty means that: the person in one of the training image and the first image is facing forward, and the person in the other one of the training image and the first image is facing backward, or, the person in one of the training image and the first image is facing left, and the person in the other one of the training image and the first image is facing right; the second difficulty means that: the person in one of the training image and the second image is facing forward, and the person in the other one of the training image and the second image is facing left or right, or, the person in one of the training image and the first image is facing backward, and the person in the other one of the training image and the second image is facing left or right; the third difficulty means that the person in the training image and the third image is facing the same direction.

Optionally, the determination module 61 is used to, for a training image, select candidate images including a different person from the training image; calculate similarity information between the training image and the candidate images, where the similarity information is determined by at least one of the following: clothing color, hat wearing, and person orientation in the training image and the candidate images; divide the candidate images into multiple sets according to the similarity information of the candidate images; select candidate images from different sets as training images in the training image pair.

Optionally, the determination module 61 is used to, for a training image, select a candidate image including a different person from the training image; perform human body detection on the candidate image to obtain a fourth human body detection image of the candidate image; use a preprocessing model to perform human key point extraction from the fourth human body detection image to obtain second human key points; according to the second human body key points, perform human body region division on the fourth human body detection image to obtain a target human body region image of the fourth human body detection image; determine mean and variance of the target human body region image of the fourth human body detection image on RGB three channels; convert the target human body region image of the fourth human body detection image into the HSV space, and calculate mean and variance on the three HSV channels after conversion into the HSV space; according to the mean and variance on the three RGB channels and the mean and variance on the three HSV channels, obtain image features after dimensionality reduction; cluster image features after dimensionality reduction of the multiple candidate images, and divide the multiple candidate images into different clusters; select candidate images from different clusters as training images in the training image pair.

Referring to FIG. 7, one embodiment of the present application further provides an electronic device 70, including a processor 71, a memory 72, and a computer program stored in the memory 72 and executable on the processor 71. When the computer program is executed by the processor 71, each process of the above dress code discrimination method or person identification model training method embodiment is implemented, and the same technical effect can be achieved, which will not be described here to avoid repetition.

One embodiment of the present application further provides a non-transitory computer-readable storage medium, including a computer program stored thereon. When the computer program is executed by the processor, each process of the above dress code discrimination method or person identification model training method embodiment is implemented, and the same technical effect can be achieved, which will not be described here to avoid repetition. The non-transitory computer-readable storage medium is, for example, a read-only memory (ROM), a random access memory (RAM), a magnetic disk or an optical disk.

It is to be noted that, in this disclosure, the terms “include”, “including” or any other variations thereof are intended to cover non-exclusive inclusion, so that a process, method, article or device including a series of elements includes not only those elements, but also other elements not explicitly listed, or also includes elements inherent to such process, method, article or device. In the absence of further restrictions, an element defined by the sentence “including a . . . ” does not exclude existence of other identical elements in the process, method, article or device including the element.

Through the description of the above embodiments, those skilled in the art can clearly understand that the above embodiment methods can be implemented by means of software plus a necessary general hardware platform, and of course by hardware, but in many cases the former is a better implementation method. Based on such an understanding, the essence of the technical solution of the present application or the part that contributes to the prior art can be embodied in the form of a software product. The software product is stored in a storage medium (such as ROM/RAM, a magnetic disk, or an optical disk), and includes a number of instructions for enabling a terminal (which can be a mobile phone, a computer, a server, an air conditioner, or a network device, etc.) to execute the methods described in each embodiment of the present application.

The embodiments of this application are described above with reference to the accompanying drawings. However, this application is not limited to the foregoing specific implementations. The foregoing specific implementations are merely illustrative rather than limitative. A person of ordinary skill in the art may derive various forms from this application without departing from the spirit of this application and the scope claimed by the claims, which are all under the protection of this application.

1. A discrimination method, comprising:
performing human body detection on a to-be-identified image to obtain a first human body detection image of a target person in the to-be-identified image;
performing human body region division on the first human body detection image to obtain a target human body region image of the target person;
using a person identification model to extract features from the target human body region image of the target person to obtain a first feature vector;
comparing the first feature vector with a second feature vector of a target human body region in a dress code sample image to obtain a comparison result; and
determining whether dress of the target human body region of the target person complies with a dress code according to the comparison result.

2. The method according to claim 1, wherein the performing human body region division on the first human body detection image, includes:
using a preprocessing model to perform human body key point extraction on the first human body detection image to obtain a first human body key point;
dividing the first human body detection image into human body regions according to the first human body key point.

3. The method according to claim 1, wherein before comparing the first feature vector with the second feature vector of the target human body region in the dress code sample image, the method further includes:
performing human body detection on the dress code sample image to obtain a second human body detection image;
performing human body region division on the second human body detection image to obtain a target human body region image of the dress code sample image;
using the person identification model to extract features from the target human body region image of the dress code sample image to obtain a second feature vector.

4. The method according to claim 1, wherein the comparing the first feature vector with a second feature vector of a target human body region in a dress code sample image to obtain a comparison result, includes:
calculating cosine similarity of the first feature vector and the second feature vector of the target human body region in the dress code sample image to obtain similarity information as the comparison result.

5. The method according to claim 1, wherein the determining whether a dress of the target human body region of the target person complies with a dress code according to the comparison result, includes:
for one target human body region of the target person, if a comparison result of N frames of the to-be-identified image including the target person indicates that similarity information between the first feature vector of the target human body region in at least M frames of the to-be-identified image and the second feature vector of the target human body region in the dress code sample image does not reach a preset threshold, determining that the dress of the target human body region does not comply with the dress code; wherein N is a positive integer greater than or equal to 1, and M is a positive integer greater than or equal to 1 and less than N.

6. A person identification model training method, comprising:
determining multiple training image pairs, wherein each of the training image pairs includes at least two training images;
performing human body detection on the training image in the training image pair to obtain a third human body detection image of the training image;
performing human body region division on the third human body detection image to obtain a target human body region image;
using a to-be-trained person identification model to perform feature extraction on the target human body region image to obtain a third feature vector;
comparing the third feature vectors of target human body regions of various training images in the training image pair to obtain a comparison result;
optimizing the to-be-trained person identification model according to the comparison result, to obtain a trained person identification model.

7. The method according to claim 6, wherein the performing human body region division on the third human body detection image, includes:
using a preprocessing model to perform human body key point extraction on the third human body detection image to obtain a third human body key point;
dividing the third human body detection image into human body regions according to the third human body key point.

8. The method according to claim 6, wherein the determining multiple training image pairs, includes:
using the preprocessing model to extract human body attribute information from candidate images to obtain human body attribute information of the candidate images;
selecting training images from the candidate images to form the training image pairs according to the human body attribute information.

9. The method according to claim 8, wherein
the human body attribute information includes human body orientation, and the selecting training images from the candidate images to form the training image pairs according to the human body attribute information, includes: selecting training images of a same person with same and/or different orientations from the candidate images as training images in the training image pair;
and/or,
the human body attribute information includes human body orientation and clothing color, and the selecting training images from the candidate images to form the training image pairs according to the human body attribute information, includes: selecting training images of different persons wearing a same color clothing and facing same orientation from the candidate images as the training images in the training image pair.

10. The method according to claim 9, wherein the selecting training images of a same person with same and/or different orientations from the candidate images as training images in the training image pair, includes:
for one training image, from multiple candidate images including the same person, selecting a first image of a first difficulty with a first probability, selecting a second image of a second difficulty with a second probability, and selecting a third image of a third difficulty with a third probability, as the training images in the training image pair;
wherein the first difficulty means that: the person in one of the training image and the first image is facing forward, and the person in the other one of the training image and the first image is facing backward; or, the person in one of the training image and the first image is facing left, and the person in the other one of the training image and the first image is facing right;
the second difficulty means that: the person in one of the training image and the second image is facing forward, and the person in the other one of the training image and the second image is facing left or right; or, the person in one of the training image and the first image is facing backward, and the person in the other one of the training image and the second image is facing left or right;
the third difficulty means that the person in the training image and the third image is facing the same direction.

11. The method according to claim 9, wherein the selecting training images of different persons wearing the same color clothing and facing same orientation from the candidate images as the training images in the training image pair, includes:
for one training image, selecting candidate images including a different person from the training image;
calculating similarity information between the training image and the candidate images, wherein the similarity information is determined by at least one of the following: clothing color, hat wearing, and person orientation in the training image and the candidate images;
dividing the candidate images into multiple sets according to the similarity information of the candidate images;
selecting candidate images from different sets as training images in the training image pair.

12. The method according to claim 6, wherein the determining multiple training image pairs, includes:
for one training image, selecting a candidate image including a different person from the training image;
performing human body detection on the candidate image to obtain a fourth human body detection image of the candidate image;
using a preprocessing model to perform human key point extraction from the fourth human body detection image to obtain second human key points;
according to the second human body key points, performing human body region division on the fourth human body detection image to obtain a target human body region image of the fourth human body detection image;
determining mean and variance of the target human body region image of the fourth human body detection image on RGB three channels;
converting the target human body region image of the fourth human body detection image into HSV space, and calculating mean and variance on three HSV channels after conversion into the HSV space;
according to the mean and variance on the three RGB channels and the mean and variance on the three HSV channels, obtaining image features after dimensionality reduction;
clustering image features after dimensionality reduction of the multiple candidate images, and dividing the multiple candidate images into different clusters;
selecting candidate images from different clusters as training images in the training image pair.

13-14. (canceled)

15. An electronic device, comprising: a processor, a memory, and a program stored in the memory and executable on the processor; the processor is used to perform:
performing human body detection on a to-be-identified image to obtain a first human body detection image of a target person in the to-be-identified image;
performing human body region division on the first human body detection image to obtain a target human body region image of the target person;
using a person identification model to extract features from the target human body region image of the target person to obtain a first feature vector;
comparing the first feature vector with a second feature vector of a target human body region in a dress code sample image to obtain a comparison result; and
determining whether dress of the target human body region of the target person complies with a dress code according to the comparison result.

16. A non-volatile computer-readable storage medium, comprising a computer program stored thereon; wherein when the program is executed by the processor, the steps of the dress code discrimination method according to claim 1 is implemented.

17. The electronic device according to claim 15, wherein when performing human body region division on the first human body detection image, the processor is used to perform:
using a preprocessing model to perform human body key point extraction on the first human body detection image to obtain a first human body key point;
dividing the first human body detection image into human body regions according to the first human body key point.

18. The electronic device according to claim 15, wherein before comparing the first feature vector with the second feature vector of the target human body region in the dress code sample image, the processor is used to perform:
performing human body detection on the dress code sample image to obtain a second human body detection image;
performing human body region division on the second human body detection image to obtain a target human body region image of the dress code sample image;
using the person identification model to extract features from the target human body region image of the dress code sample image to obtain a second feature vector.

19. The electronic device according to claim 15, wherein when comparing the first feature vector with a second feature vector of a target human body region in a dress code sample image to obtain a comparison result, the processor is used to perform:
calculating cosine similarity of the first feature vector and the second feature vector of the target human body region in the dress code sample image to obtain similarity information as the comparison result.

20. The electronic device according to claim 15, wherein when determining whether a dress of the target human body region of the target person complies with a dress code according to the comparison result, the processor is used to perform:
for one target human body region of the target person, if a comparison result of N frames of the to-be-identified image including the target person indicates that similarity information between the first feature vector of the target human body region in at least M frames of the to-be-identified image and the second feature vector of the target human body region in the dress code sample image does not reach a preset threshold, determining that the dress of the target human body region does not comply with the dress code; wherein N is a positive integer greater than or equal to 1, and M is a positive integer greater than or equal to 1 and less than N.

21. An electronic device, comprising: a processor, a memory, and a program stored in the memory and executable on the processor; wherein when the program is executed by the processor, the processor is used to perform the method according to claim 6.

22. The electronic device according to claim 21, wherein when performing human body region division on the third human body detection image, the processor is used to perform:
using a preprocessing model to perform human body key point extraction on the third human body detection image to obtain a third human body key point;
dividing the third human body detection image into human body regions according to the third human body key point.
